(19) United States
(12) Patent Application Publication
(10) Pub. No.: US 2004/0015782 A1
(43) Pub. Date: Jan. 22, 2004

(54) Templating method for automated generation of print product catalogs

(76) Inventors: Young Francis Day, Plainsboro, NJ (US); Peiya Liu, East Brunswick, NJ (US); Liang H. Hsu, West Windsor, NJ (US)

Correspondence Address: Siemens Corporation, Intellectual Property Department, 186 Wood Avenue South, Iselin, NJ, 08830, US

(21) Appl. No.: 10/197,101

(22) Filed: Jul. 17, 2002

(51) Int. Cl. G06F 17/00

(52) U.S. Cl. 715/517; 715/530

(57) ABSTRACT

A document publishing system comprises a page splitter taking a document comprising elements as input and defining at least one page of the document, a template processor and an editor connected to the template processor, defining a style and layout. The document publishing system further comprises a document converter connected to the page splitter and the editor, wherein the document converter determines a script according to the style and layout and the at least one page of the document.

### BACKGROUND OF THE INVENTION

1. Field of the Invention

The present invention relates to document formatting, and more particularly to, templating XML documents to product scripts.

2. Discussion of Related Art

XML (Extensible Markup Language) is a standard format for structured documents and data on the Web. An XML document can be viewed on-line by converting the XML document into HTML documents. Most web browsers cannot print HTML documents into high-quality printouts required by commercial product catalogs. There is no fixed-size page model concept in the browser's online printing. The page breaks can occur at inappropriate places and there is no control in this online hardcopy printing. Additional limitations in, for example, the ability to printing page header and footer information.

Therefore, for high-quality hardcopy printing of XML documents, desktop publishing software such as Corel Ventura may be needed. The XML documents can be imported into the publishing software by manually cutting and pasting the XML documents (e.g., as ASCII). The documents can then be printed using the software's functionality. Non-textual content such as images or special structure such as tables may need to be imported separately. The process of importing can be tedious, error-prone and not scalable to large documents. Additionally, it can become a daunting process if there are a large number of documents to be imported for subsequent printing.

ArborText Epic Publisher/Editor is one of the tools that can be used to import, edit and print XML documents. However, the print quality of Epic's output is not flexible enough in generating versatile layout of the documents, particularly having color texts and graphical layouts, due to the limitation of its page formatting and styling method.

Therefore, a need exists for a system and method for automatically converting XML documents into print product catalogs according to print templates.

### SUMMARY OF THE INVENTION

According to an embodiment of the present invention, a document publishing system comprises a page splitter taking a document comprising elements as input and defining at least one page of the document, a template processor and an editor connected to the template processor, defining a style and layout. The document publishing system further comprises a document converter connected to the page splitter and the editor, wherein the document converter determines a script according to the style and layout and the at least one page of the document.

The document publishing system comprises a mapper connected to the editor and the document converter, defining a map between the elements and a user-defined style.

The document publishing system comprises a publication generator executing the script. The elements are XML elements. The template processor defines a template, wherein the template is refined by the style and layout.

According to an embodiment of the present invention, a document publishing system comprises a web browser providing data entry services, an edit assistant coupled to the web browser for accepting data and a database coupled to the edit assistant, wherein the database stores the data. The document publishing system further comprises a catalog generator coupled to the database, for processing the data stored in the database and a formatting servlet coupled to the catalog generator, for accepting the data from the catalog generator and providing a printing service.

The data stored in the database is HTML data. The data stored in the database comprises text data and graphical data. The catalog generator generates XML files from the data stored in the database. The formatting servlet formats the data from the catalog generator according to a publishing specification.

According to an embodiment of the present invention, a method of creating a document comprises the steps of splitting a document into at least one page, determining a template for formatting the at least one page and defining a style and layout of the template. The method further comprises determining a script according to the style and layout of the template and the at least one page of the document.

The method defines a map between the elements and a user-defined style. The method executes the script to produce a publication.

The elements are XML elements. The template is refined by the style and layout.

Determining a script further comprises the steps of copying the template as the initial generation script file, parsing the document as a document object model tree and performing a search of the document object model tree. The step further comprises determining one or more nodes in the document object model tree, determining one or more document elements and generating a script corresponding to each element. Each script is appended to a generation script file.

### BRIEF DESCRIPTION OF THE DRAWINGS

Preferred embodiments of the present invention will be described below in more detail, with reference to the accompanying drawings:

FIG. 1 is a diagram of a print product catalog generation system according to an embodiment of the present invention;

FIG. 2 is a diagram of a print catalog generation method according to an embodiment of the present invention; and

FIG. 3 is a flow chart of a print product catalog script generation method according to an embodiment of the present invention.

### DETAILED DESCRIPTION OF PREFERRED EMBODIMENTS

The present invention is related to a templating method for automatically converting XML documents, based on specified print templates, into print product catalogs. These catalogs can be any web based document, for example, an HTML document such as an on-line newspaper, or an automobile brochure. An XML page splitter can be used to break XML documents into smaller segments called pages. Based on a specified template, a document converter can process the split XML documents into pages and creates a print catalog generation script. A publication generator can execute the script to produce a desired print catalog.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM) and input/output (I/O) interface(s). The computer platform also includes an operating system and microinstruction code. The various processes and functions described herein may either be part of the microinstruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

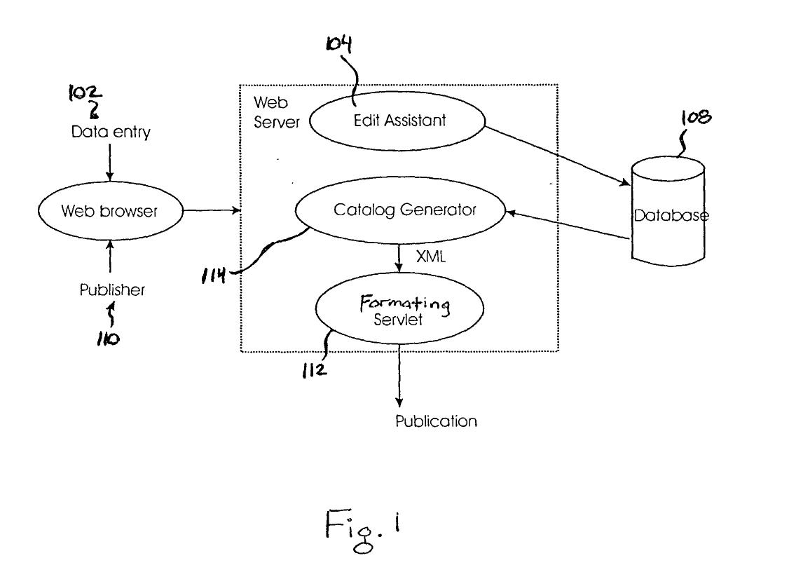

According to an embodiment of the present invention, the print product catalog generation system can be implemented as a part of an overall product catalog generation system for both online and hardcopy print. Referring to FIG. 1, the product catalog data 102 can be entered through an edit assistant 104 using a web browser 106 as an interface. The edit assistant 104 can be a web application. The user needs no knowledge of XML. The user enters data as paragraphs, lists, tables, graphics, etc. The edit assistant 104 can process and save the entered data into a database 108. A publisher 110 can invoke a print process 112 (e.g., XML-to-Ventura servlet), which uses XML files generated by a catalog generator 114. The catalog generator 114 processes the data from the database 108.

According to an embodiment of the present invention, a method of generating a print product catalog can use XML files composed in other ways than through the catalog generator 114, such as generated by another XML editor tool or edited by a text editor.

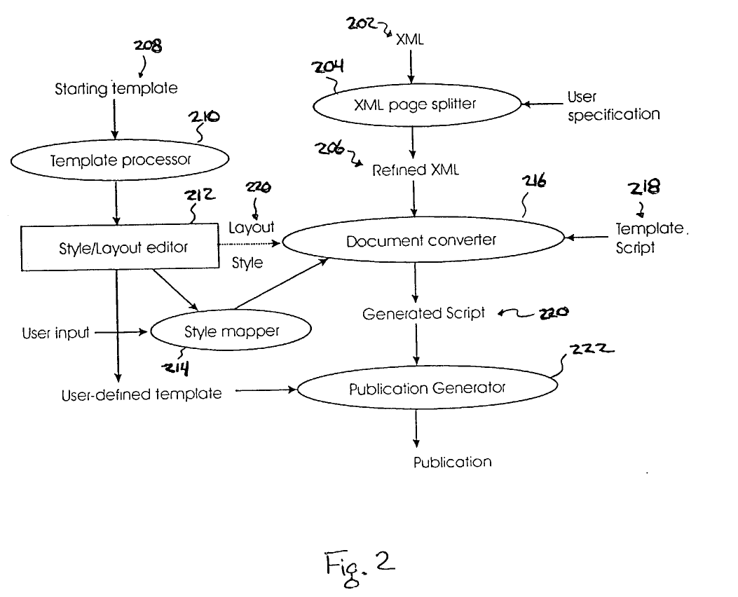

According to an embodiment of the present invention, a print product catalog generation method is shown in FIG. 2. The source XML documents 202 for a print catalog comprise a top-level document referencing a number of sub-documents. The XML documents are pre-processed by XML page splitter 204 to produce one or more refined XML documents 206. The re-process is an XML content segmentation for splitting XML documents into small units. Each unit includes about the content of one print catalog page, for example, a print catalog page in Ventura. The page splitter 204 can take optional user specifications to force the start or end of a page. Otherwise, the page splitter 204 uses the beginning of a sub-document and a heuristic method to determine the beginning and the end of the page. This heuristic method determines an approximate amount of text, graphic and tabular information that can be fit into a page. The heuristic method compiles the text, graphic and tabular information into a segment (e.g., page).

A print templating process starts from an initial template with only master pages, which describe the basic layout of a publication and ends with a specified print template. The initial template 208 is further processed by template processor 210 to generate a refined template with product-specific information such as document title, catalog version, etc. The refined template can be further edited by using style/layout editor 212 to add styles and user-defined layouts. Style is the set of formatting constructs. Each construct has a unique name and various formatting properties such as font family, font size, indentation, etc. A user-defined layout can comprise Ventura content pages such that each page defines a fixed arrangement/configuration of frames including text, graphics and/or tables. The publisher can position and size each frame, name some specific frames such as document starting frames or graphic frames. After the user specifies the styles, a mapping of XML elements to the user-specified style, e.g., a Ventura style, can be implemented through a style mapper 214. The style mapper 214 further refines the print catalog templates, and generates a mapping file. Each entry in the mapping file indicates that an XML element with certain context is mapped to the user-specified style. If the style is not specified, a default mapping can be used.

Document converter 216 takes a pre-defined template script 218, specified print templates 220 and split XML 206 as input, and processes the split XML 206 to produce a print product catalog generation script 222. The refined templates comprise information about print layout and style, and product catalog style mappings for XML. The template script comprises a set of building block functions that can handle importing tasks for various XML elements and functionalities such as importing a paragraph, finding a frame, inserting a table cell, etc. These functions can be called in the generated script 220.

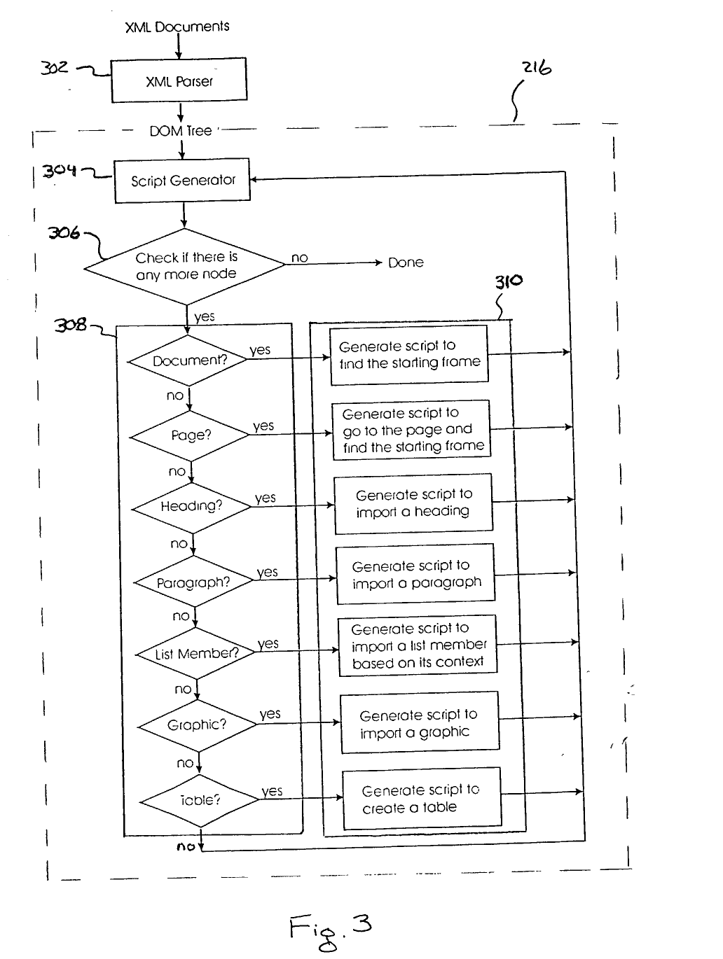

Referring to FIG. 3, a conversion method comprises copying the template script as the initial generation script file. The XML document can be parsed 302 as a DOM (document object model) tree. The DOM is an interface allowing programs and scripts to access and update document content, structure and style. A depth-first search of the DOM tree is then invoked 304. The conversion method determines whether a node exists 306. When a node is encountered, a set of operations can be carried out. Document elements such as sub-document, page, heading, paragraph, graphic, table and list can be recognized 308. Scripts corresponding to each recognized element can be generated 310 and appended to the generation script file 304.

When a new page is encountered during the conversion, a layout can be selected. A user-specified page layout can be selected. If a layout has not been specified, a default page layout can be chosen. The default page layout can be based on the content of the page. When the DOM tree has been traversed, a complete generation script file can be generated. The conversion can also perform periodic saves and error recovery. During the execution of the script, if an error is determined, the method can write to a log file, save the already-created content, and quit the generation method.

The publication generator can launch a publication application, for example, Ventura, through OLE (object linking and embedding) automation to execute the generated script to create a Ventura format for printing.

Having described embodiments for a system and method for automatically converting XML documents into print product catalogs according at print templates, it is noted that modifications and variations can be made by persons skilled in the art in light of the above teachings. It is therefore to be understood that changes may be made in the particular embodiments of the invention disclosed which are within the scope and spirit of the invention as defined by the appended claims. Having thus described the invention with the details and particularity required by the patent laws, what is claimed and desired protected by Letters Patent is set forth in the appended claims.

What is claimed is:

1. A document publishing system comprising:
a page splitter taking a document comprising elements as input and defining at least one page of the document;
a template processor;
an editor connected to the template processor, defining a style and layout; and
a document converter connected to the page splitter and the editor, wherein the document converter determines a script according to the style and layout and the at least one page of the document.

2. The document publishing system of claim 1, further comprising a mapper connected to the editor and the document converter, defining a map between the elements and a user-defined style.

3. The document publishing system of claim 1, further comprising a publication generator executing the script.

4. The document publishing system of claim 1, wherein the elements are XML elements.

5. The document publishing system of claim 1, wherein the template processor defines a template, wherein the template is refined by the style and layout.

6. A document publishing system comprising:
a web browser providing data entry services;
an edit assistant coupled to the web browser for accepting data;
a database coupled to the edit assistant, wherein the database stores the data;
a catalog generator coupled to the database, for processing the data stored in the database; and
a formatting servlet coupled to the catalog generator, for accepting the data from the catalog generator and providing a printing service.

7. The document publishing system of claim 6, wherein the data stored in the database is HTML data.

8. The document publishing system of claim 6, wherein the data stored in the database comprises text data and graphical data.

9. The document publishing system of claim 6, wherein the catalog generator generates XML files from the data stored in the database.

10. The document publishing system of claim 6, wherein the formatting servlet formats the data from the catalog generator according to a publishing specification.

11. A method of creating a document comprising the steps of:
splitting a document into at least one page;
determining a template for formatting the at least one page;
defining a style and layout of the template; and
determining a script according to the style and layout of the template and the at least one page of the document.

12. The method of claim 11, further comprising defining a map between the elements and a user-defined style.

13. The method of claim 11, further executing the script to produce a publication.

14. The method of claim 11, wherein the elements are XML elements.

15. The method of claim 11, wherein the template is refined by the style and layout.

16. The method of claim 11, wherein the step of determining a script further comprises the steps of:
copying the template as the initial generation script file;
parsing the document as a document object model tree;
performing a search of the document object model tree;
determining one or more nodes in the document object model tree;
determining one or more document elements; and
generating a script corresponding to each element.

17. The method of claim 16, wherein each script is appended to a generation script file.
